(19) United States
(12) Patent Application Publication
(10) Pub. No.: US 2005/0107933 A1
(43) Pub. Date: May 19, 2005

(54) Airbag apparatus

(75) Inventors: Shuusaku Kuroda, Hyogo (JP); Seigo Tanaka, Hyogo (JP); Masanobu Fumiiwa, Hyogo (JP); Akira Sugie, Hyogo (JP)

Correspondence Address: OLIFF & BERRIDGE, PLC, P.O. BOX 19928, ALEXANDRIA, VA, 22320, US

(73) Assignee: FUJITSU TEN LIMITED, Kobe-shi (JP)

(21) Appl. No.: 10/990,190

(22) Filed: Nov. 17, 2004

(30) Foreign Application Priority Data
Nov. 17, 2003 (JP) 2003-386804

(51) Int. Cl. B60R 22/00

(52) U.S. Cl. 701/45; 701/46; 280/735; 180/271

(57) ABSTRACT

An airbag apparatus includes a controller, a prediction unit, and a sampling-period control unit. The controller conducts sampling of acceleration values output from a plurality of acceleration sensors disposed on a vehicle and controls inflation of an airbag based on the sampled acceleration values. The prediction unit predicts a collision direction in which collision with another vehicle would occur. When the prediction unit predicts the collision direction, the sampling-period control unit shortens a sampling period for the acceleration sensor disposed in the predicted collision direction in comparison with sampling period for the other acceleration sensors. After the sampling-period control unit shortens the sampling period, the controller determines whether or not to inflate the airbag, based on the sampled acceleration values output from the acceleration sensor disposed in the predicted collision direction.

### 1. FIELD OF THE INVENTION

The present invention relates to an airbag apparatus, which protects occupants by means of inflating an airbag upon detection of a collision, and more particularly to an airbag apparatus, which enables early determination of occurrence of collision, as well as shortening the time required to determine occurrence of collision, by means of predicting a collision direction (collision portion).

### 2. DESCRIPTION OF THE RELATED ART

As an airbag apparatus for protecting occupants, there has hitherto been known an airbag apparatus, which protects in-vehicle occupants by means of instantly inflating an airbag accommodated in the center of a driver's seat (a steering wheel) in the event of detection of a collision (head-on collision) with another vehicle. In addition, there has recently been known an airbag apparatus, which protects occupants, in the event of a collision with another vehicle on the side of a vehicle, by means of inflating a side airbag disposed on the side of the vehicle. JP-A-Hei.11-59323 discloses a technique of prohibiting transmission of other signals when collision is predicted based on a detection signal obtained from an output from an acceleration sensors (G sensors). U.S. Pat. No. 5,936,549 discloses a technique of predicting in advance a collision pattern against an obstacle by means of distance measuring sensors.

### SUMMARY OF THE INVENTION

Hereinafter, one of airbag apparatuses will be described briefly. The airbag apparatus has G sensors, an ECU (electronic control unit), and side airbags. The G sensors are provided inside of pillars disposed on the left side and the right side of a vehicle, and respectively detect a lateral (side) collision. The ECU is mounted on the approximate center of the vehicle, and make a decision based on G level values (acceleration values) detected by the respective G sensors. The side airbags protect occupants. In a practical situation, the G sensors detect G level values, which are generated upon collision with another vehicle; the ECU performs a threshold value determination and arithmetic processing; and the side airbag is inflated by means of ignition of a target squib.

The “threshold value determination by the ECU” referred to here means the following processing. The ECU integrates outputs (acceleration values) from the G sensors for a predetermined period, and when the integral value exceeds a predetermined threshold value, the ECU determines that collision by another vehicle has occurred. That is, the threshold value serves as a criterion for inflation of a side airbag. By means of employing acceleration values in such a manner, error detection is prevented in the event that a momentary output is generated, whereby judgment accuracy on collision is increased.

However, the airbag apparatus described above has the following problems. In order to detect lateral (side) collision with another vehicle, the airbag apparatus described above has the plural G sensors that detect a lateral (side) collision and are disposed in the respective pillars of the vehicle. The G level values output from the plurality of G sensors are transmitted to the ECU by communication. The ECU performs arithmetic processing and the threshold value determination, whereby a side airbag is inflated.

However, since it is hard for the ECU to process (integrate) the G level values detected by the respective G sensors simultaneously, the ECU integrates the G level values from the respective G sensors in a predetermined sequence. As the result, there is a problem that, when an actual collision occurs, the ECU may not be able to process the G level values from the G sensor disposed at a collision point. On the other hand, if the ECU processes the G level values from the plural G sensors simultaneously, there is a problem that loads are imposed on the ECU. In particular, since a distance (space) between (the inner side of) a vehicle and an occupant is small, required is an airbag apparatus which can determine occurrence of a collision at an early timing, from a viewpoint of protecting occupants.

The invention has been conceived in light of the hitherto-described problems, and provides an airbag apparatus, which can shorten the time required to determine occurrence of a collision when a lateral collision with another vehicle is detected.

To solve the problem cited above and to achieve the object, according to one embodiment of the invention, an airbag apparatus includes a controller, a prediction unit, and a sampling-period control unit. The controller conducts sampling of acceleration values output from a plurality of acceleration sensors disposed on a vehicle and controls inflation of an airbag based on the sampled acceleration values. The prediction unit predicts a collision direction in which collision with another vehicle would occur. When the prediction unit predicts the collision direction, the sampling-period control unit shortens a sampling period for the acceleration sensor disposed in the predicted collision direction in comparison with sampling period for the other acceleration sensors. After the sampling-period control unit shortens the sampling period, the controller determines whether or not to inflate the airbag, based on the sampled acceleration values output from the acceleration sensor disposed in the predicted collision direction.

With this configuration, since delay due to communication processing and arithmetic processing is prevented, delay in inflation of a side airbag can be prevented. In addition time required to determine occurrence of collision can be shortened. As a result, an advantage of the ability to reliably protect occupants is achieved.

According to one embodiment of the invention, an airbag apparatus includes a controller, a prediction unit, and a sampling-period control unit. The controller conducts sampling of acceleration values output from a plurality of acceleration sensors disposed on a vehicle and controls inflation of an airbag based on the sampled acceleration values. The prediction unit predicts a collision direction in which collision with another vehicle would occur. When the prediction unit predicts the collision direction, the sampling-period control unit gives priority in the sampling of the acceleration values to the acceleration sensor disposed in the predicted collision direction. After the sampling-period control unit gives the priority, the controller conducts the sampling of the acceleration values in accordance with the priority and determines whether or not to inflate the airbag, based on the sampled acceleration values output from the acceleration sensor to which the priority is given.

With this configuration, the time required to determine occurrence of a collision can be shortened.

### BRIEF DESCRIPTION OF THE DRAWINGS

FIG. 1 is a descriptive view showing a collision pattern where another vehicle collides a vehicle equipped with an airbag apparatus according to an embodiment of the invention.

FIG. 2 is a schematic view showing arrangement of G sensors of the vehicle shown in FIG. 1.

FIG. 3 is a general functional block diagram showing a configuration of the airbag apparatus according to an embodiment of the invention.

FIG. 4 is a functional block diagram of a collision determination procedure control section 50 shown in FIG. 3.

FIG. 5 is a flowchart showing a procedure of an airbag apparatus according to a first embodiment.

FIG. 6 is a time chart showing a sampling period according to the first embodiment.

FIG. 7 is a flowchart showing a procedure of an airbag apparatus according to a second embodiment.

FIG. 8 is a flowchart showing a procedure of an airbag apparatus according to a third embodiment.

FIG. 9A is a time chart showing a normal sampling sequence and an example of an emergency sampling sequence with giving priority. FIG. 9B is a time chart showing the normal sampling sequence and another example of the emergency sampling sequence.

FIG. 10 is a flowchart showing a procedure of an airbag apparatus according to a fourth embodiment.

FIG. 11 is a time chart showing the normal sampling sequence and the emergency sampling sequence with giving priority to a safing G sensor 31.

FIG. 12 is a flowchart showing a procedure of an airbag apparatus according to a fifth embodiment.

FIG. 13 is a configuration view showing a collision pattern storage table 60 according to a sixth embodiment.

FIG. 14 is a characteristic chart showing a relation between integral values from a G sensor and a first threshold value.

FIG. 15 is a configuration view showing another example of the collision pattern storage table 60.

FIG. 16 is a configuration view showing still another example of the collision pattern storage table 60.

FIG. 17 is a flowchart showing a procedure of an airbag apparatus according to a seventh embodiment.

FIG. 18A is a descriptive view showing a collision pattern where a normal vehicle collides with a user's vehicle. FIG. 18B is a descriptive view showing another collision pattern where a vehicle, which is high in vehicle height, collides with the user's vehicle.

FIG. 19 is a characteristic chart showing a relation among integral values generated by a collision with a normal vehicle, integral values generated by a collision with a vehicle having high vehicle height, and the first threshold value.

FIG. 20 is a characteristic chart showing a relation between integral values generated by the collision with the vehicle having high vehicle height and the first threshold value, and showing a case where the first threshold value is changed according to the seventh embodiment.

FIG. 21 is a view schematically showing a configuration of an airbag apparatus according to an eighth embodiment.

FIG. 22 is a flowchart showing a procedure of the airbag apparatus according to the eighth embodiment.

FIG. 23 is a time chart showing sampling period in the eighth embodiment.

FIG. 24 is a view schematically showing a configuration of an airbag apparatus according to a ninth embodiment.

FIG. 25 is a flowchart showing a procedure of the airbag apparatus according to the ninth embodiment.

FIG. 26 is a time chart showing sampling period in the ninth embodiment.

### DETAILED DESCRIPTION OF THE PREFERRED EMBODIMENT

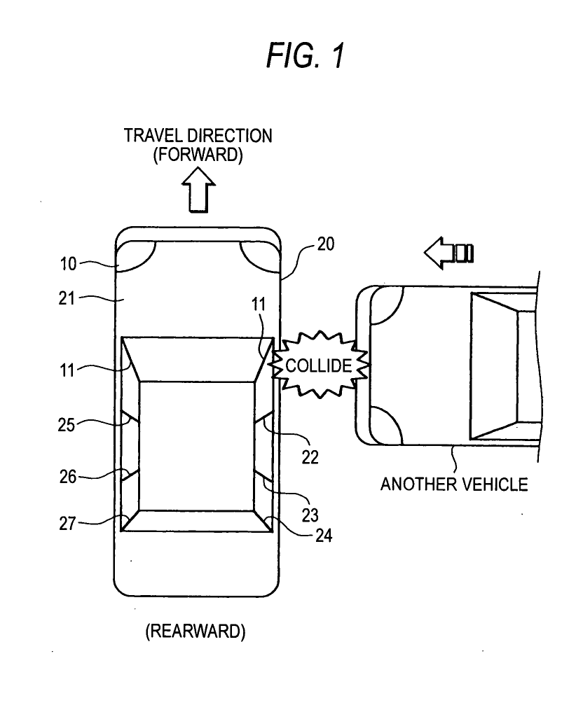

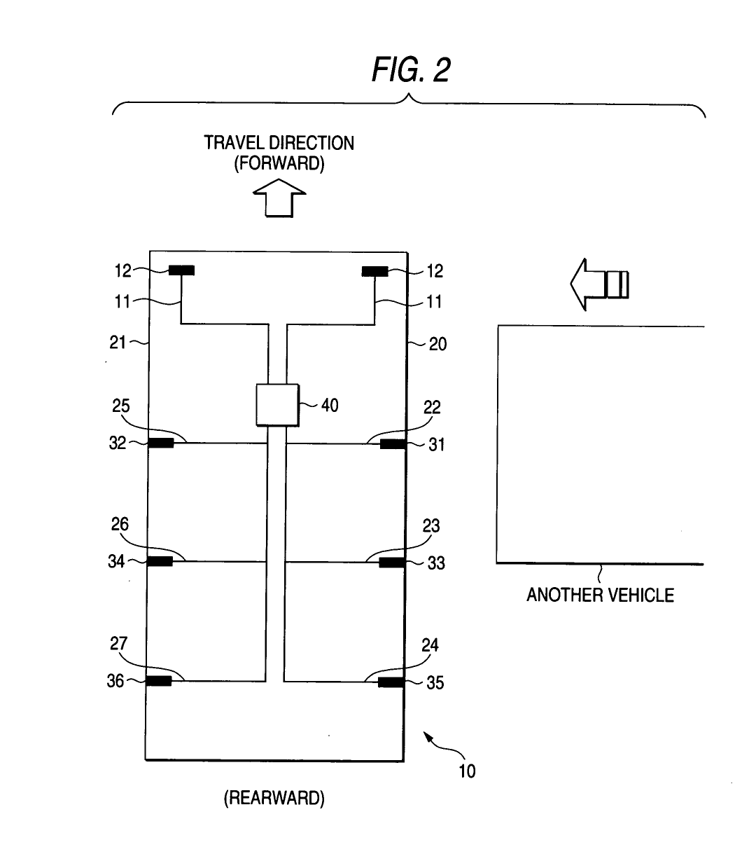

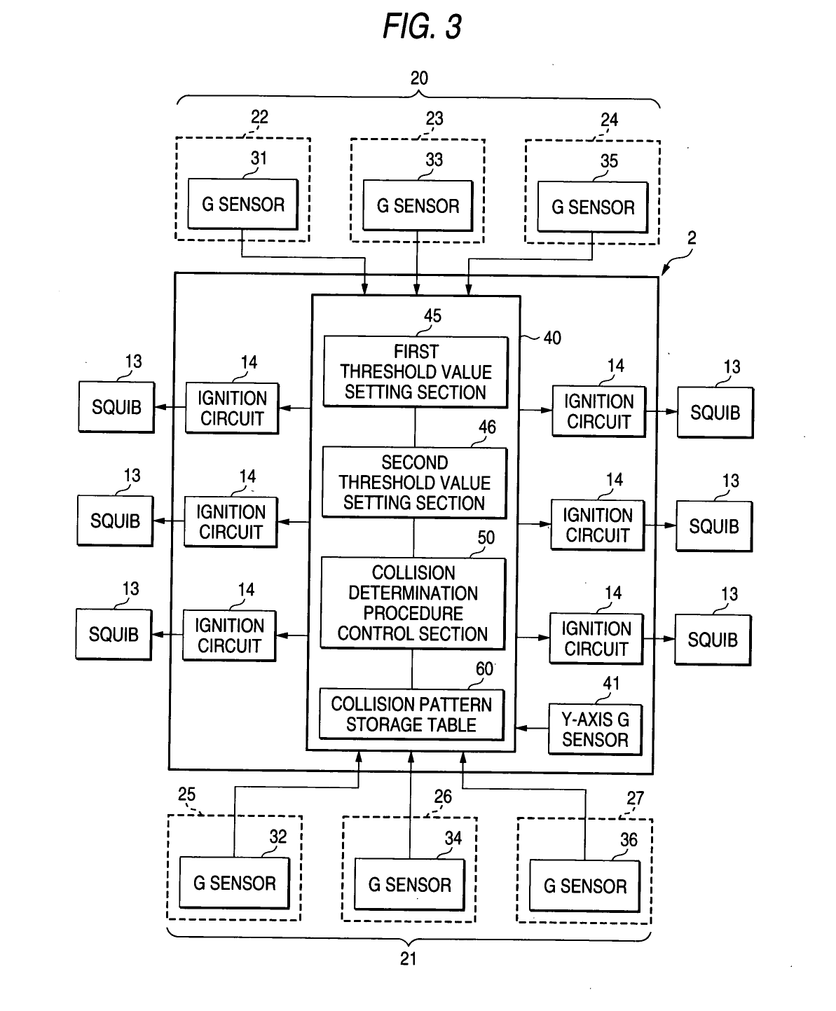

Hereinafter, preferred embodiments of the invention will be described in detail with reference to the attached drawings. FIG. 1 is a descriptive view showing a collision pattern where another vehicle collides a vehicle equipped with an airbag apparatus according to an embodiment of the invention. FIG. 2 is a schematic view showing arrangement of acceleration sensors of a vehicle shown in FIG. 1. FIG. 3 is a general functional block diagram showing a configuration of the airbag apparatus according to an embodiment of the invention. In the following description, an overview and features of the airbag apparatus according to an embodiment will be described, and thereafter details of a control method for a side impact airbag and other embodiments will be described. Hereinafter, an acceleration sensor will be referred to as a “G sensor”. Note that the present invention is not limited to embodiments described below.

### First Embodiment

As shown in FIGS. 1 and 2, the airbag apparatus includes a plurality of G sensors 31 to 36 (side-impact sensors) for detecting a lateral collision, at predetermined positions (on the right and left sides) of a vehicle 10. An airbag controller 2 (FIG. 3) predicts a collision direction (collision position) of collision with another vehicle on the basis an integral value (G integral value) of acceleration values output from the respective G sensors 31 to 36. The airbag controller 2 performs processing of shortening the sampling period of G sensors disposed in the predicted collision direction (predicted collision portion) or performs processing of giving a preference in the sampling order to the sampling of the G sensors disposed in the predicted collision direction (predicted collision portion). Consequently, by virtue of the above, in addition to detecting collision direction of a collision with another vehicle prior to the collision, the airbag apparatus according to the embodiments of the invention can prevent delayed inflation of an airbag caused by delay due to communication processing, threshold value processing, and arithmetic processing. As a result, protection of occupants can be surely accomplished. The “sampling” means that the airbag controller 2 (e.g. the ECU) integrates acceleration values output from one of the G sensors 31 to 36. The “sampling period” means a time period for which the airbag controller 2 integrates acceleration values output from one of the G sensors 31 to 36, and is usually set to approximate 0.5 ms.

As shown in FIGS. 1 and 2, in pillars 11 disposed at the front of the vehicle 10, front G sensors 12 for detecting a head-on collision are provided. In right and left pillars (right pillars 22 to 24 and left pillars 25 to 27) on the respective sides (on the right side surface 20, on the left side surface 21) of the vehicle 10, a plurality of G sensors 31 to 36 for detecting a collision with another vehicle on the respective sides 20, 21 are provided. As will be described later, ECU 40 activates an ignition circuit 14 and a squib 13 on the basis of an integral value of acceleration values obtained by the respective G sensors, whereby a side airbag (unillustrated) for protecting occupants is inflated. The G sensors for detecting the acceleration values may be used as a G sensor for an ABS (antilock brake system) or that for brake control.

The ECU 40, to which detection data (acceleration values) detected by the respective G sensors 31 to 36 are transmitted and which determines whether or not the side airbag is inflated, is mounted in the approximate center of the vehicle 10. The acceleration values from the plurality of G sensors 31 to 36 are transmitted to the ECU 40 by communication. As a result of arithmetic processing and threshold value determination by means of the ECU 40, an airbag is inflated. Furthermore, a Y-axis G sensor 41 for detecting an acceleration value in lateral direction of the vehicle (Y-axis direction) is mounted inside the ECU 40. The squib 13 includes an explosive section activated by the ignition circuit 14 to thus rapidly inflate the side airbag, a heater section performing rapid electric heating, and a lead wire energizing the heater.

It is noted that in the embodiments of the invention, each G sensor generates analog acceleration values; converts the analog acceleration values into digital acceleration values; and output the digital acceleration values. However, the ECU 40 may perform the A/D conversion.

As shown in FIG. 3, the airbag controller 2 includes a first threshold value setting section 45, a second threshold value setting section 46, a collision determination procedure control section 50, and a collision pattern storage table 60. Of these sections, the collision determination procedure control section 50 has the function of sampling (integrating) acceleration values output from each of the G sensors 31 to 36 to obtain a G integral signal, the function of determining a collision direction and collision position of collision with another vehicle based on the obtained integral value, and a function of controlling the sampling (e.g. sampling period) of the respective G sensors, on the basis of the determined collision direction or collision position.

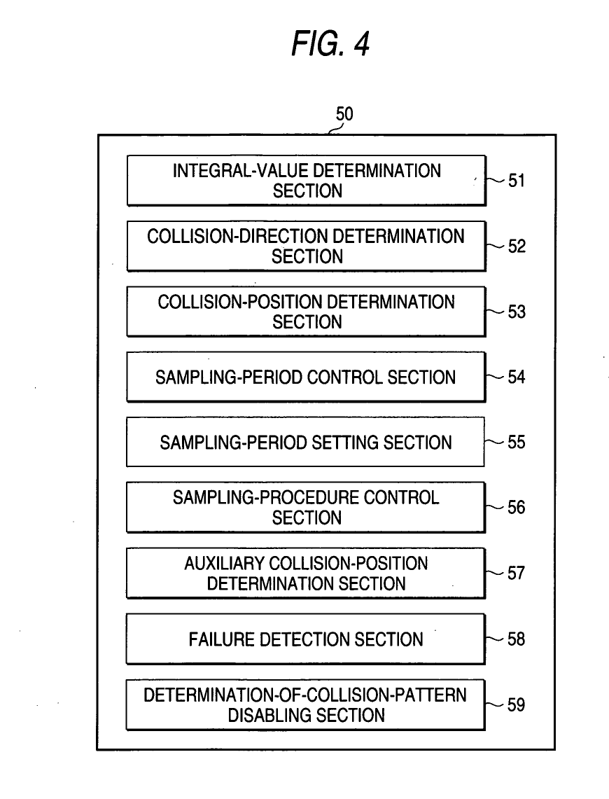

As shown in FIG. 4, the collision determination procedure control section 50 includes an integral-value determination section 51, a collision-direction prediction section 52, a collision-position prediction section 53, a sampling-period control section 54, a sampling-period setting section 55, a sampling-procedure control section 56, an auxiliary collision-position prediction section 57, a failure detection section 58, and a determination-of-collision-pattern disabling section 59.

The first threshold value setting section 45 has a function of setting a first threshold value serving as a criterion for inflation of the side airbag. The second threshold value setting section 46 sets a second threshold value, which is a threshold value lower than the first threshold value set by the first threshold value setting section 45. The integral-value determination section 51 has a function of determining whether or not the integral value of acceleration values output from each of the G sensors 31 to 36 exceeds the second threshold value. The collision-direction prediction section 52 has a function of determining (predicting) a direction in which a collision with another vehicle may occur on the basis of a position of at least one of the G sensors 31 to 36, an integral value of acceleration values output from which has been determined to exceed the second threshold value by the integral-value determination section 51. The collision-position prediction section 53 has a function of specifying a position of collision with the other vehicle on the basis of a position of at least one of the G sensors 31 to 36, an integral value of acceleration values output from which has been determined to exceed the second threshold value by the integral-value determination section 51.

The sampling-period control section 54 has a function of, on the basis of the collision direction determined (predicted) by the collision-direction prediction section 52, controlling the sampling period of G sensors located in the vicinity of the thus-determined collision direction (in the same direction).

In addition, the sampling-period control section 54 has the sampling-period setting section 55 for shortening and setting the sampling period for G sensors on either side; i.e., on the left and right sides. In the embodiment, the sampling-period setting section 55 sets the sampling period to 0.25 msec.

The sampling-sequence control section 56 has a function of causing the G sensors disposed on the right side surface 20 or on the left side surface 21 to perform sampling in a prioritized manner, on the basis of the collision direction determined by the collision-direction prediction section 52.

The auxiliary collision-position prediction section 57 has a function of assigning a G sensor on the side opposite to the position of the G sensor specified by the collision-position prediction section 53 as a determination factor in determination of collision position. The failure detection section 58 has a function of determining failure of the G sensors. The determination-of-collision-pattern disabling section 59 has a function of prohibiting determination with use of collision patterns.

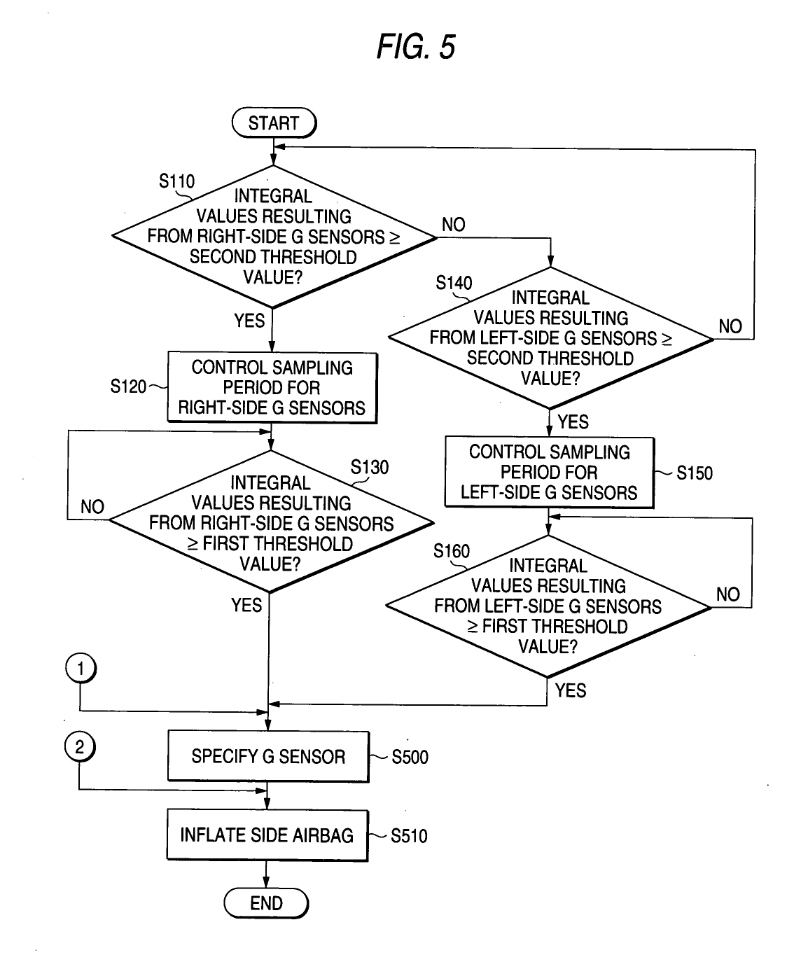

Next, the first embodiment of the present invention will be described in detail with reference to FIG. 5. In the first embodiment, a collision direction (either on the right side surface 20 or on the left side surface 21), in which a vehicle would be collided with another vehicle, is determined (predicted) on the basis of an integral value of acceleration values output from each of the G sensors 31 to 36; and the sampling period of the G sensors located in the thus-determined predicted-collision side are shortened.

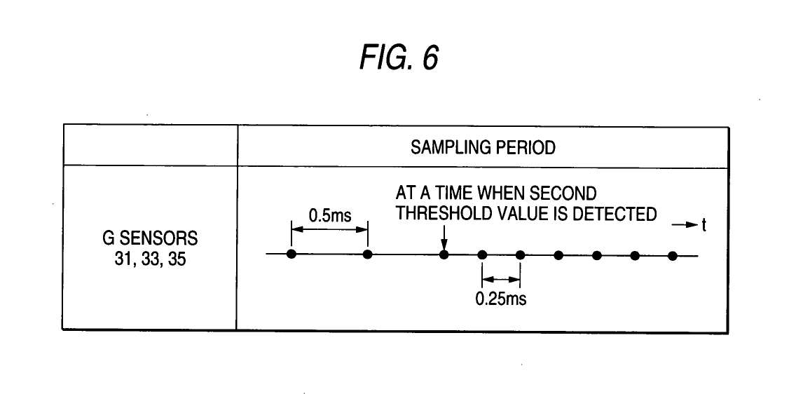

Hereinafter, details of an airbag apparatus according to the first embodiment will be described with reference to FIGS. 5 and 6. FIG. 5 is a flowchart showing a procedure of the airbag apparatus according to the first embodiment of the invention. Here, the first threshold value in the flowchart serves as a criterion for inflation of the airbag (a timing, shown in FIG. 3, at which an ignition signal is transmitted from the ignition circuit 14 to the squib 13). The second threshold value is lower than the first threshold value.

More specifically, as shown in the flowchart of FIG. 5, among the plurality of G sensors 31 to 36 (FIG. 2), the ECU 40 first integrates acceleration values output from G sensors on one side of the vehicle (on the right side surface 20 or on the left side surface 21) subsequently. Then, the integral-value determination section 51 determines as to whether or not the integral value of the acceleration values output from any one of the G sensors 31, 33, 35 on the right side surface 20 exceeds the second threshold value (the integral value from the right-side G sensor≧second threshold value) (step S110). When the integral-value determination section 51 determines that the integral value of the acceleration values of any one of the G sensors 31, 33, 35 on the right side surface 20 exceeds the second threshold value in step S110 (“Yes” in step S110), the possibility of collision with another vehicle on the right side surface 20 of the vehicle 10 is determined to be high. Accordingly, the sampling-period control section 54 shortens the sampling period of the G sensors 31, 33, 35 provided on the right side surface 20 (step S120).

The “sampling period” means a period for which the ECU 40 integrates acceleration values output from each of the G sensors. In the embodiment, the sampling-period setting section 55 sets about half of the normal sampling period as the sampling period. More specifically, as shown in FIG. 6, the sampling-period setting section 55 changes the sampling period for the G sensors 31, 33, 35 from a normal sampling period (0.5 ms) to an emergency sampling period (0.25 ms). Reliability of determination in step S110 is improved by means of making the determination on the plurality of G sensors 31, 33, 35 on the right side surface 20; however, the determination may be made on a single G sensor (e.g., the G sensor 31) rather than on the plurality of G sensors.

On the other hand, when in step S110, the integral-value determination section 51 determines that none of the integral values of the acceleration values output from the G sensors 31, 33, 35 on the right side surface 20 exceeds the second threshold value (“No” in step S110), processing proceeds to step S140. In step S140, the integral-value determination section 51 determines as to whether or not an integral value of acceleration values from any one of the plurality of G sensors 32, 34, 36 on the left side surface 21 exceeds the second threshold value (the integral value from left-side G sensor≧the second threshold value) (step S140). When in step S140, the integral-value determination section 51 determines that the integral value of the acceleration values output from any one of the G sensors 32, 34, 36 on the left side surface 21 exceeds the second threshold value (“Yes” in step S140), possibility of collision with another vehicle on the left side surface 21 is determined to be high. Accordingly, the sampling-period control section 54 shortens the sampling period for the G sensors 32, 34, 36 provided on the left side surface 21 (step S150).

In the embodiment, the processing for shortening the sampling period for the G sensors located on the collision side (on the right side surface 20 or on the left side surface 21) is performed. However, in consideration of a total load imposed on an airbag apparatus 1, the airbag controller 2 may defer timing of A/D conversion value of the respective G sensors on the opposite side.

Hereinafter, in the embodiment, a procedure in the flowchart shown in FIG. 5 will be described on an assumption that the other vehicle collides on the right side surface 20 of the vehicle. More specifically, the sampling-period control section 54 shortening the sampling period for the G sensors 31, 33, 35 in step S120 (step S120).

Subsequently, the integral-value determination section 51 determines as to whether or not the integral value of the acceleration value output from any one of the plurality of G sensors 31, 33, 35 on the right side surface 20 exceeds the first threshold value (the integral value from right-side G sensor≧the first threshold value) (step S130). As has been described, the first threshold value is a threshold value for inflation of the airbag. This determination is processing for determining an actual collision. When in step S130 the integral-value determination section 51 determines that an integral value of the acceleration values output from any one of the plurality of G sensors 31, 33, 35 on the right side surface 20 exceeds the first threshold value (“Yes” in step S130), the ECU 40 specifies the G sensor (step S500) and inflates a side airbag corresponding to the thus-specified G sensor (step S510) More specifically, when the integral-value determination section 51 determines that an integral value of the acceleration values output from the G sensor 31 exceeds the first threshold value, an ignition signal is transmitted from the ignition circuit 14 to the squib 13. Upon activation of the squib 13, the side airbag corresponding to the G sensor 31 is inflated, thereby protecting occupants.

As described above, the Y-axis G sensor 41 for detecting the lateral collision (lateral impact) with another vehicle on the right side surface 20 or the left side surface 21 is mounted inside the vehicle 10. Accordingly, a collision direction of collision with another vehicle may be determined by means of utilizing the Y-axis G sensor 41. In this case, the Y-axis G sensor 41 outputs acceleration values. When an integral value of the acceleration values exceeds a predetermined threshold value for determining a collision on the right side surface 20, sampling-period control of the G sensors on the right side surface 20 is executed. When an integral value of the acceleration values exceeds a predetermined threshold value for determining collision on the left side surface 21, sampling-period control of the G sensors on the left side surface 21 is executed.

When the Y-axis G sensor 40 is utilized for predicting a collision direction, the collision detection can be predicted more easily and surely. Furthermore, time required for collision determination can be shortened.

### Second Embodiment

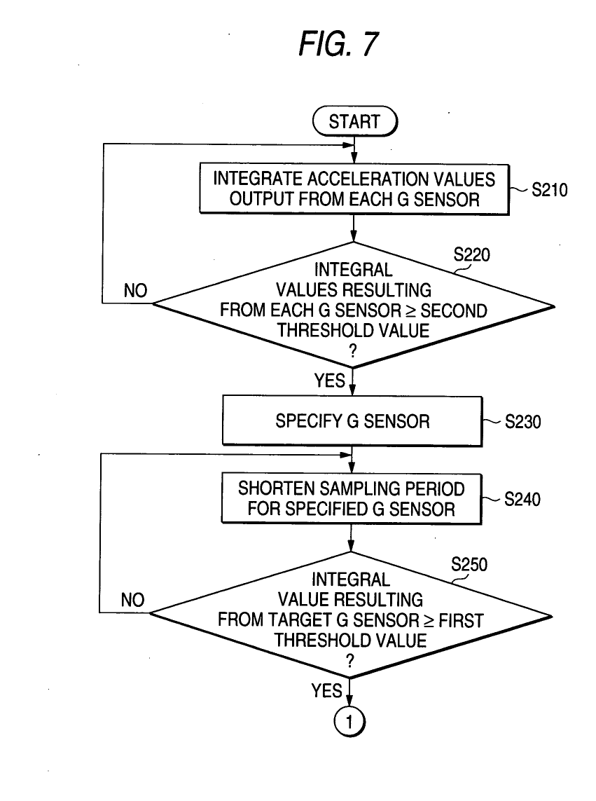

Next, a second embodiment of the invention will be described in detail with reference to FIG. 7. In the first embodiment, a collision direction (on the right side surface 20 or on the left side surface 21) of a collision with another vehicle is determined (predicted) on the basis of integral values of acceleration values output from the plurality of G sensors, and the sampling period for the G sensors located in the thus-determined (predicted) collision side is shortened. However, in the second embodiment, the collision-position prediction section 53 (FIG. 4) specifies a collision portion of collision with another vehicle; and the sampling period of only the G sensor located at the collision position specified by the collision-position prediction section 53 is shortened.

More specifically, as shown in the flowchart shown in FIG. 7, the ECU 40 integrates acceleration values output from the plurality of G sensors 31 to 36 subsequently (step S210). Then, the integral-value determination section 51 determines as to whether or not the integral value of the acceleration values output from each of the G sensors 31 to 36 exceeds the second threshold value (step S220). If determination is “No” in step S220, the process returns to step S210. For example, if the integral-value determination section 51 determines that the integral value from the G sensor 31 does not exceed the second threshold value in step S220, then the ECU 40 integrates acceleration values output from another G sensor 32. On the other hand, if determination is “Yes” in step S220, the process proceeds to step S230. The collision-position prediction section 53 specifies the G sensor the integral value from which is determined to exceed the second threshold value (step S230) Then, the sampling-period control section 54 shortens the sampling period for only the thus-specified G sensor (step S240).

For instance, when in step S220 the integral-value determination section 51 determines that the integral value from the G sensor 31 exceeds the second threshold value, the sampling-period control section 54 shortens the sampling period for only the G sensor 31. The processing of shortening the sampling period in this case is, as described in FIG. 6, changing the sampling period for the G sensor 31 from the normal sampling period (0.5 msec) used in normal times to the emergency sampling period (0.25 msec). Subsequently, the ECU 40 integrates acceleration values output only from the specified G sensor (the G sensor 31 in the above case) for the emergency sampling period; the integral-value determination section 51 determines as to whether or not the obtained integral value exceeds the first threshold value (step S250). If the integral value exceeds the first threshold value (“Yes” in step S250), a side airbag corresponding to the specified G sensor is inflated (step S510). On the other hand, if the integral value does not exceed the first threshold value (“No” in step S250), the process returns to the beginning of step S250. That is, the ECU 40 integrates acceleration values output from the specified G sensor again.

According to the second embodiment, the collision-position prediction section 53 specifies a collision position where collision would occur, that is, a G sensor an integral value from which exceeds the second threshold value, and the sampling-period control section 54 shortens sampling period for the thus-specified G sensor. Therefore, time required for collision determination can be shortened.

### Third Embodiment

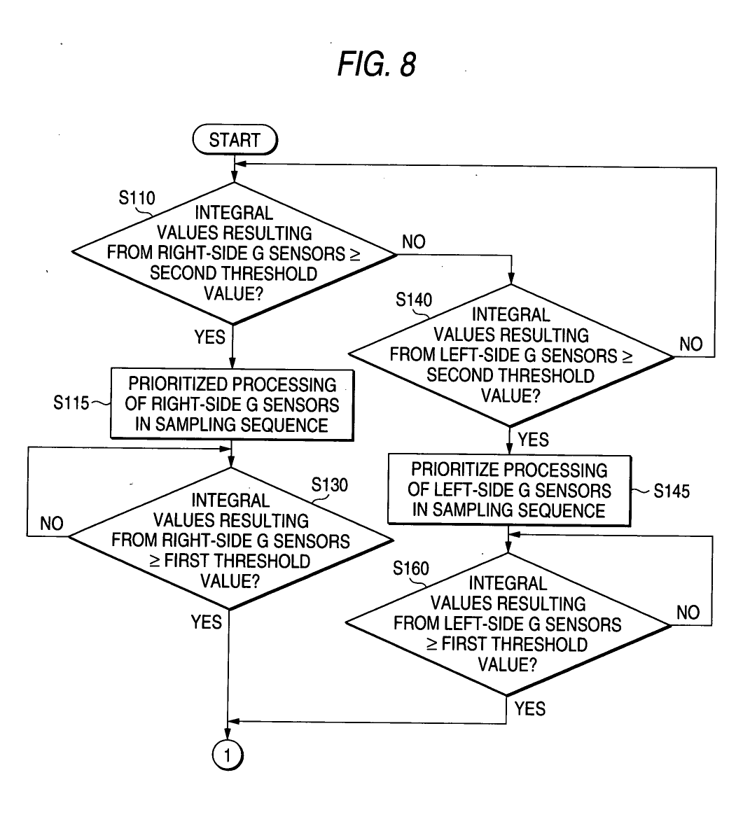

Next, a third embodiment of the invention will be described in detail with reference to the flowchart shown in FIG. 8. In the respective embodiments shown in FIGS. 8 to 25 below, detailed descriptions of the same processes as those in the hitherto-described flowchart shown in FIG. 5 will be omitted.

In the hitherto-described first and second embodiments, a collision direction (on the right side surface 20 or on the left side surface 21) or a collision position of a collision with another vehicle is determined (predicted) on the basis of G level values (G integral values) detected by the plurality of G sensors, and the sampling period of the plurality of G sensors located in the thus-determined predicted-collision side or only the G sensor located at the collision-predicted portion is shortened (0.5 ms→0.25 ms). However, in the third embodiment, the sampling-sequence control section 56 causes the plurality of G sensors located in the collision direction, which has been determined (predicted) by the collision-direction prediction section 53, to perform sampling with priorities.

More specifically, as shown in the flowchart of FIG. 8, among the plurality of G sensors 31 to 36 (FIG. 2), the ECU 40 first integrates acceleration values output from G sensors on one side (on the right side surface 20 or on the left side surface 21) subsequently. Then, the integral-value determination section 51 determines as to whether or not the integral value of the acceleration values output from any one of the plurality of G sensors 31, 33, 35 on the right side surface 20 exceeds the second threshold value (the integral value from right-side G sensor≧second threshold value) (step S110). When the integral-value determination section 51 determines that the integral value of the acceleration values of any one of the G sensors 31, 33, 35 on the right side surface 20 exceeds the second threshold value in step S110 (“Yes” in step S110), the possibility of collision with another vehicle on the right side surface 20 of the vehicle 10 is determined to be high. Accordingly, the sampling-sequence control section 56 gives priority to the G sensors 31, 33, 35 disposed on the right side surface 20 in integrating acceleration values (step S115). In other words, the ECU 40 integrates acceleration values output from the G sensors 31, 33, 35 disposed on the right side surface 20 in a prioritized manner over the other G sensors 32, 34, 36. Then, the integral-value determination section 51 determines as to whether or not an integral value of acceleration values output from any one of the G sensors 31, 33, 35 exceeds the first threshold value (integral value from the right-side G sensor≧first threshold value) (step S130).

In contrast, when in step S110 the integral-value determination section 51 determines that none of the G sensors 31, 33,35 on the right side surface 20 exceeds the second threshold value (“No” in step S110), then the integral-value determination section 51 determines as to whether or not an integral value of acceleration values output from any one of the G sensors 32, 34, 36 on the left side surface 21 exceeds the second threshold value (integral value from the left-side G sensor≧second threshold value) (step S140). When in step S140 the integral-value determination section 51 determines that an integral value of acceleration values output from any one of the G sensors 32, 34, 36 on the left side surface 21 exceeds the second threshold value (“Yes” in step S140), the possibility of collision with another vehicle on the left side surface 21 is determined to be high. Accordingly, the sampling-sequence control section 56 gives priority to the G sensors 32, 34, 36 disposed on the left side surface 21 in integrating acceleration values (step S145). Hereinafter, the integral-value determination section 51 determines as to whether or not an integral value of acceleration values output from any one of the G sensors 32, 34, 36 exceeds the first threshold value (integral value from left-side G sensor≧first threshold value) (step S160). Hereinafter, the same procedure as described above (steps S500 to S510 in FIG. 5) is performed, whereby a corresponding side airbag is inflated.

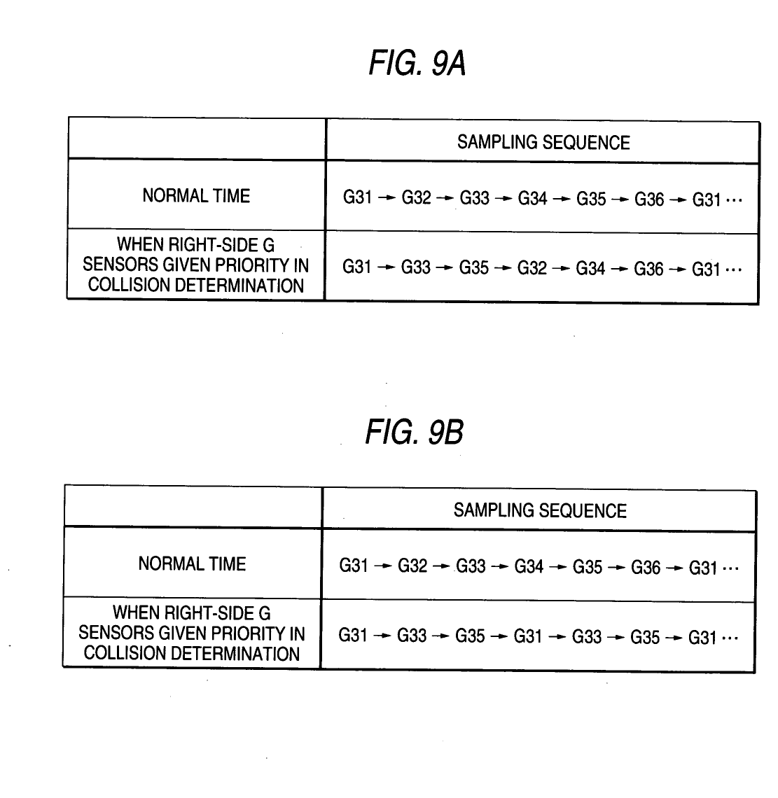

FIG. 9 shows a time chart of priority sampling according to the third embodiment (in FIG. 9, a G sensor is denoted only as “G”). FIG. 9A shows one example of the priority sampling. More specifically, in FIG. 9A, a normal sampling sequence of the G sensors 31 to 36 (i.e., a sequence of integrating acceleration values) is “G sensor 31→G sensor 32→G sensor 33→G sensor 34→G sensor 35→G sensor 36”. The ECU 40 integrates acceleration values output from G sensors on the right side surface 20 and those on the left side surface 21 alternately. Specifically, the ECU 40 receives acceleration signals from one of the G sensors on one side for the sampling period while integrating the received acceleration values for the sampling period. Thereafter, the ECU 40 receives signals from another G sensor on the other side and repeats the same processes. In FIG. 9A, when a collision side, which would be collided with another vehicle, is determined to be the right side surface 20 in step S110 shown in FIG. 8, the G sensors 31, 33, 35 disposed on the right side surface 20 are given a higher priority in sampling sequence than the other G sensors disposed on the left side surface 21. Therefore, the sampling process is performs in a sequence of “G sensor 31→G sensor 33→G sensor 35→G sensor 32→G sensor 34→G sensor 36”.

FIG. 9B shows another example of the priority sampling. In stead of the sequence shown in FIG. 9A, the sampling process may be performed in a sequence of “G sensor 31→G sensor 33→G sensor 35→G sensor 31→G sensor 33→G sensor 35” as shown in FIG. 9B after the collision-direction prediction section 52 determines that the right side surface 20 would be collided with another vehicle. In other words, the ECU 40 integrates acceleration values output only from the G sensors 31, 33, 35 disposed in the right side surface 20.

In either sampling sequences with giving priority shown in FIG. 9A or 9B, time required for collision determination can be shortened.

The collision determination procedure control section 50 controls the procedure of steps S110 through S150. The third embodiment describes processing for giving priority in integrating acceleration values to the respective G sensors disposed in the collision direction (on the right side surface 20 or on the left side surface 21). However, when consideration is given to the overall load imposed on the airbag apparatus 1, control operation may be performed such that a timing, at which values detected by the respective G sensors disposed on the opposite side are converted, is delayed.

### Fourth Embodiment

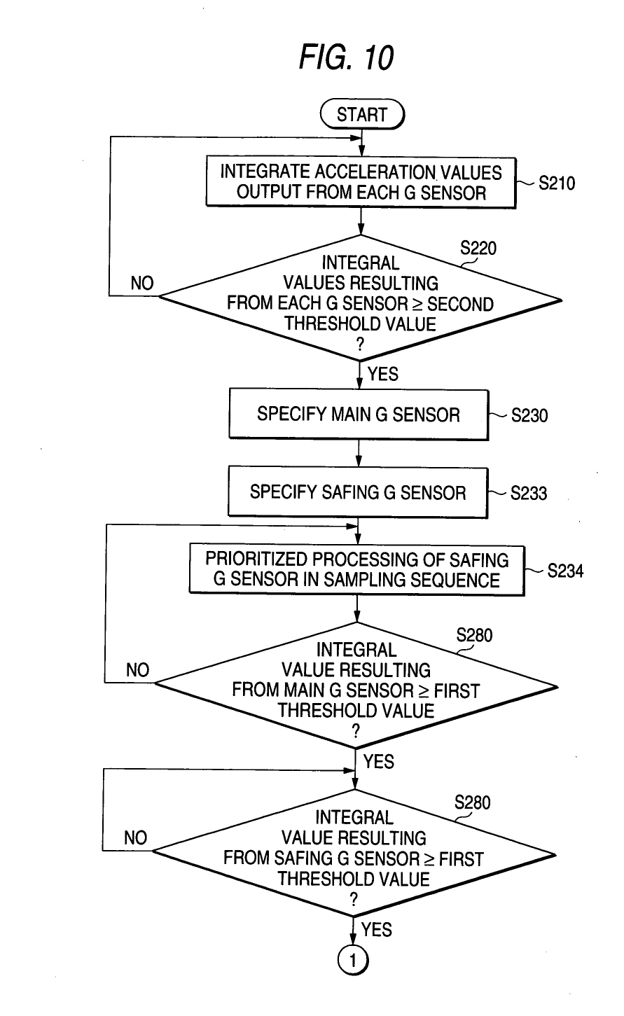

Next, a fourth embodiment according to the invention will be described in detail by reference to FIG. 10. The fourth embodiment utilizes the auxiliary collision-position prediction section 57 that employs another G sensor disposed on a side opposite to a collision position of a G sensor, which has been determined (specified) by the collision-position prediction section 53, as a determination factor (safety function) in determination of collision position. Also, the sampling-sequence control section 56 gives priority in integrating acceleration values to the G sensor determined (specified) by the auxiliary collision-position prediction section 57.

When both of an integral value from a G sensor specified by the collision-position prediction section 53 and an integral value from another G sensor specified by the auxiliary collision-position prediction section 57 exceed the first threshold value, the side airbag is inflated.

More specifically, as shown in the flowchart of FIG. 10, the ECU 40 subsequently integrates acceleration values output from each of the G sensors 31 to 36 (step S210). Then, the integral-value determination section 51 determines as to whether or not the integral value from any one of the G sensors 31 to 36 exceeds the second threshold value (step S220). Thereafter, the collision-position prediction section 53 specifies a G sensor the integral value from which exceed the second threshold value (step S230) (hereinafter, the G sensor specified by the collision-position prediction section 53 will be referred to as a “main G sensor”). The auxiliary collision-position prediction section 57 specifies, as a safing G sensor, a G sensor located at a position opposite to the G sensor specified by the collision-position prediction section 53 (step S233). For instance, when the collision-position prediction section 53 specifies the G sensor 32 in step S230, the auxiliary collision-position prediction section 57 specifies the G sensor 31 as the safing G sensor. Then, the sampling-sequence control section 56 gives priority in integrating acceleration values to the thus-specified G sensor 31 (step S234).

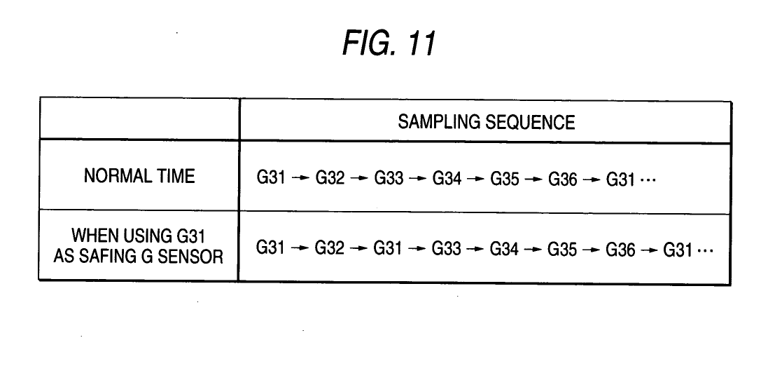

For example, it is assumed that another vehicle collides on the G sensor 32 side of the left side surface 21. In this case, the G sensor 32 serves as a main G sensor; and the G sensor 31 located at the position opposite to the G sensor 32 serves as the safing G sensor, that is, a safing sensor. Accordingly, in the fourth embodiment, when the collision-position prediction section 53 specifies the G sensor 32, the sampling-sequence control section 56 gives priority to the G sensor 31 serving as the safing sensor for the G sensor 32 in integrating acceleration values. More specifically, as shown in FIG. 11, the sampling sequence with giving priority to the G sensor 31 is as follows: “G sensor 31→G sensor 32→G sensor 31→G sensor 33→G sensor 34→G sensor 35→G sensor 36”.

Returning to the flowchart shown in FIG. 10, a procedure subsequent to step S234 will be described. The integral-value determination section 51 determines as to whether or not an integral value from the G sensor 32 serving as the main G sensor exceeds the first threshold value (integral value from main G sensor≧first threshold value) (step S280). Then, the integral-value determination section 51 determines as to whether or not an integral value from the G sensor 31 serving as the safing G sensor exceeds the first threshold value (integral value from safing G sensor≧first threshold value) (step S300). When the both of integral values from the G sensors 31, 32 exceed the first threshold value (“Yes” in S 280 and “Yes” in S300), the same procedure as described above (steps S500 to S510 in FIG. 5) is performed, whereby a corresponding side airbag is inflated.

As described above, in the fourth embodiment, a G sensor located at a position opposite to a G sensor located at a predicted collision position is made to serve as a safing sensor for preventing erroneous inflation of a side airbag. Consequently, a mechanical sensor, which is generally employed in an airbag apparatus for the purpose of safing, can be eliminated.

### Fifth Embodiment

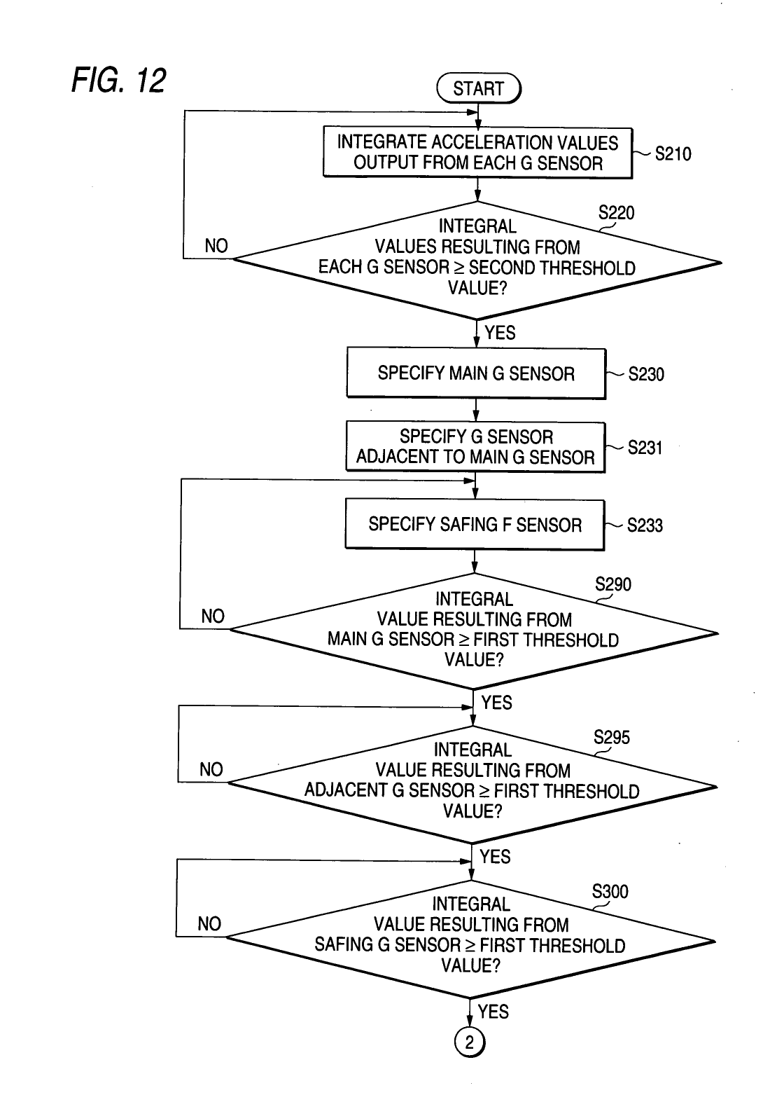

A fifth embodiment of the invention will be described in detail with reference to FIG. 12. The fifth embodiment utilizes another G sensor adjacent to the main G sensor as the determination factor for inflation of airbag, in addition to the main G sensor and the safing G sensor. When all of integral values from the main G sensor, the adjacent G sensor, and the safing G sensor exceed the first threshold level, the side airbag is inflated.

More specifically, as shown in the flowchart of FIG. 12, the ECU 40 subsequently integrate acceleration values output from each of the plurality of G sensors 31 to 36 (step S210). Then, the integral-value determination section 51 determines as to whether or not an integral value from any one of the G sensors 31 to 36 exceeds the second threshold value (step S220) Thereafter, the collision-position prediction section 53 specifies, as the main G sensor, a G sensor the integral value from which exceeds the second threshold value (step S230), and also specifies a G sensor adjacent to the thus-specified main G sensor (step S231). Subsequently, the auxiliary collision-position prediction section 57 specifies a G sensor at a position opposite to the main G sensor as the safing G sensor (step S233). Hereinafter, in steps S290, S295, and S300, the integral-value determination section 51 determines as to whether or not integral values from the main G sensor, the adjacent G sensor, and the safing G sensor exceed the first threshold value subsequently. When all the three integral values exceed the first threshold value, the airbag is inflated (step S510).

According to the fifth embodiment, since the main G sensor, the adjacent G sensor, and the safing G sensor are used for collision determination, it can be surely prevented to inflate an airbag erroneously.

### Sixth Embodiment

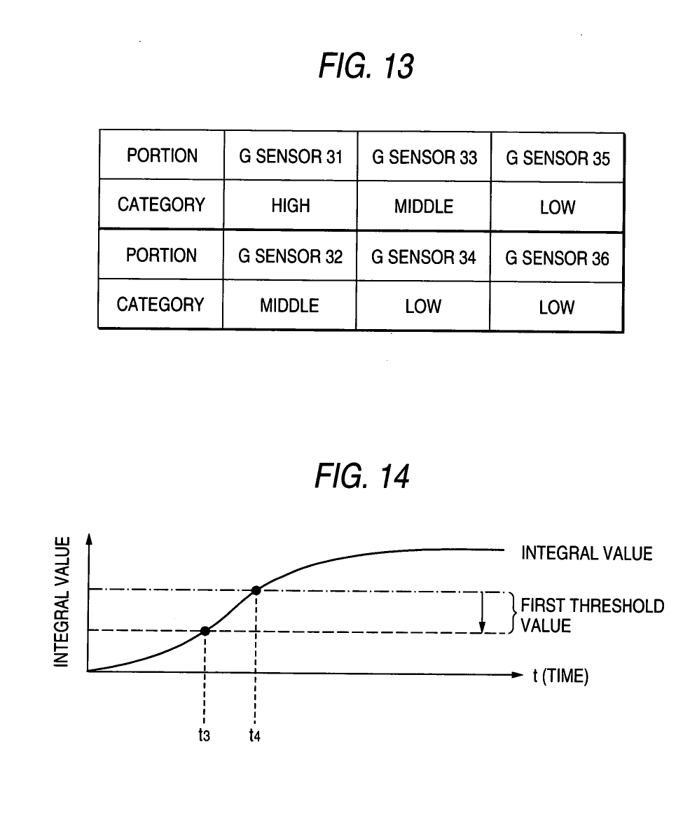

A sixth embodiment of the invention will be described in detail with reference to FIG. 13. In the sixth embodiment, the collision pattern storage table 60 temporarily stores collision patterns (integral values) from the plurality of G sensors 31 to 36. Of the integral values that result from the G sensors 31 to 36 and are temporarily stored in the collision pattern storage table 60, the first threshold value setting section 45 changes the first threshold value for the G sensor the integral value from which is the largest. The collision determination procedure control section 50 performs determination procedures on the basis of the thus-changed new first threshold value.

FIG. 13 shows the collision pattern storage table 60. The collision pattern storage table 60 stores the integral values from the G sensors 31 to 36 disposed in the respective pillars 22 to 27. The collision pattern storage table 60 categorizes integral values as “high”, “middle”, or “low”. For example, the collision pattern storage table 60 has fourth threshold value and fifth threshold value, which is larger than the fourth threshold value. When an integral value is lower than the fourth threshold value, the collision pattern storage table 60 categorizes the integral value as “low”. When an integral value is higher than the fifth threshold value, the collision pattern storage table 60 categorizes the integral value as “high”. When an integral value is between the fourth and fifth threshold values, the collision pattern storage table 60 categorizes the integral value as “middle”. It is noted that the first threshold value is higher than the fifth threshold value. In the collision pattern storage table 60 shown in FIG. 13, among the integral values from the G sensors 31 to 36, the integral value from the G sensor 31 disposed in the pillar 22 on the right side surface 20 is the highest and is categorized as “high”. Accordingly, the collision-position prediction section 53 predicts that lateral collision with another vehicle on the pillar 22 on the right side would occur. For this reason, in the sixth embodiment, the first threshold value setting section 45 changes in advance the first threshold value, which serves as a criterion for inflation of a side airbag, for the G sensor 31 which has been predicted (specified) on the basis of the collision pattern storage table 60.

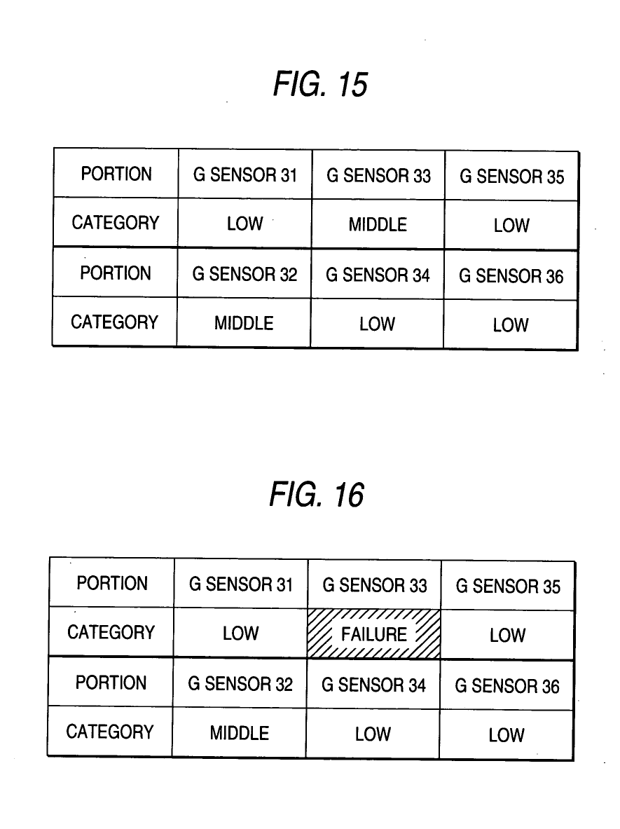

FIG. 14 is a characteristic chart showing a relation between an integral value from a normal G sensor and the first threshold value. In the sixth embodiment, the first threshold value setting section 45 changes (lowers) the first threshold value for the G sensor located at a position where possibility of collision is high. As a result, time required to determine the collision can be shortened as shown in FIG. 14 (t4→t3) as shown in FIG. 14. As described above, the first threshold value is lowered for improving collision determination property. However, the first threshold setting section 45 may switch the first threshold value to another predetermined threshold value (third threshold value), rather than changing the first threshold value. Furthermore, for instance, in a case where all stored integral values are categorized as “low” or “middle” as shown in FIG. 15, the determination of collision may performed continuously on the basis of the existing base threshold value.

In addition, as shown in FIG. 16, in the case where the failure detection section 58 detects failure of a G sensor, the collision determination sequence control section 50 may be prevented from performing the determination of collision. Furthermore, in the case where the failure detection section 58 has detected failure of a G sensor, an integral value (or a category) from the failed G sensor may be estimated based on integral values from the other G sensors. More specifically, by means of referring to categories of integral values from the G sensors 31, 32, 33, 34, 35, and 36 stored in the collision pattern storage table 60, an integral value from the G sensor 33, which is determined to have failed, may be estimated as “middle”.

### Seventh Embodiment

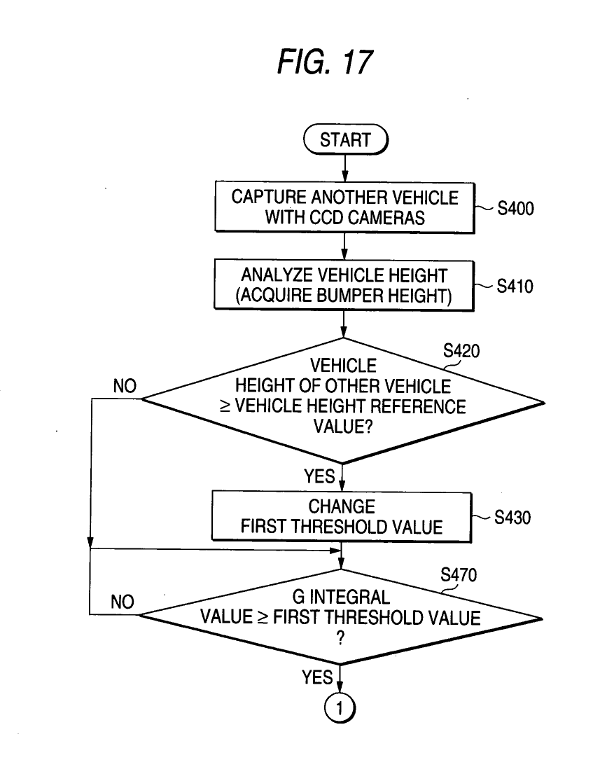

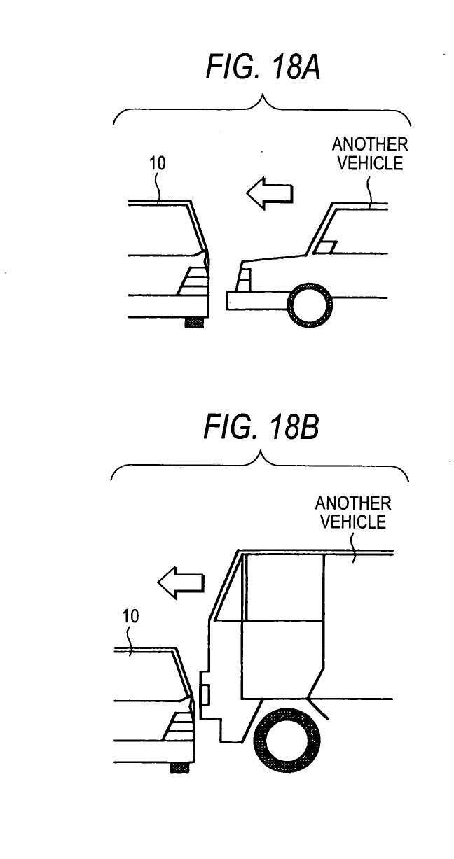

Next, a seventh embodiment of the invention will be described in detail with reference to FIG. 17. FIG. 17 is a flowchart showing a procedure according to the seventh embodiment. In the seventh embodiment, an image capturing section such as a CCD camera for capturing (photographing) image information relating to another vehicle are disposed at a predetermined position of the vehicle. The first threshold value setting section 45 changes the first threshold value on the basis of a vehicle height of the other vehicle captured by CCD cameras. More specifically, the CCD cameras are respectively disposed on the right side surface 20 and the left side surface 21 of the vehicle 10. The ECU 40 analyzes the image data relating to the other vehicle obtained by the CCD cameras to determine a vehicle height of the other vehicle (height of a bumper). The first threshold value setting section 45 changes the first threshold value for inflation of an airbag on the basis of thus-obtained vehicle height.

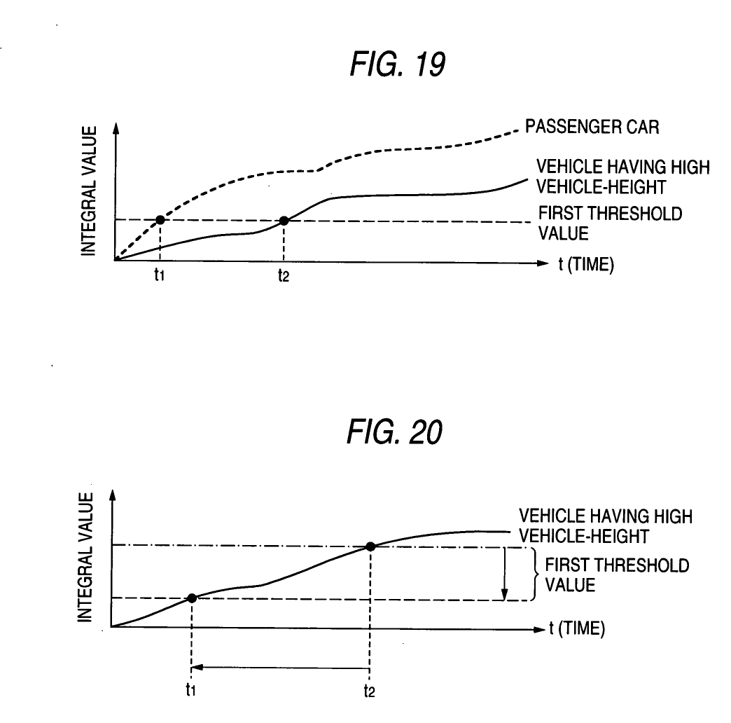

As shown in FIG. 18A, a bumper of a normal vehicle (another vehicle) collides with the pillar of the vehicle 10. However, as shown in FIG. 18B, in contrast to such a normal vehicle, a vehicle which is high in vehicle height (i.e., whose bumper is located high), such as a truck, may collide with the vehicle 10 on the door window glass which has comparatively low strength. Accordingly, even if a vehicle, which is high in vehicle height, collides with the vehicle 10, an integral value from each of the G sensors may be low. That is, as shown in FIG. 19, an integral value caused by collision with a vehicle, which is high in vehicle height, such as a truck, do not rise quickly. Therefore, there is a possibility that a delay in collision determination occurs (collision determination time t1<collision determination time t2). The seventh embodiment focuses on this variation of integral values in accordance with a vehicle height. When the ECU 40 recognizes another vehicle, which is high in vehicle height, from the image information obtained by the CCD camera, the first threshold value setting section 45 changes the first threshold value serving as the criteria for inflation of the airbag. In the seventh embodiment, the vehicle height of the other vehicle is obtained with using the image information from the CCD camera. However, another-vehicle information such as vehicle height may be obtained through a communication device that conducts inter-vehicles communication, rather than the CCD camera.

Next, the flowchart shown in FIG. 17 will be described. In the seventh embodiment, first, the CCD cameras capture another vehicle in the vicinity of the vehicle 10 (step S400). The ECU 40 obtains image information relating to the other vehicle from the CCD cameras (step S410). A vehicle height reference value corresponds to a vehicle height of a normal vehicle. Subsequently, the ECU 40 determines as to whether or not the vehicle height of the other vehicle obtained from the image information in step S410 is higher than the vehicle height reference value (vehicle height of the other vehicle≧vehicle height reference value) (step S420). When in step S420 the ECU 40 determines that the vehicle height of the other vehicle is higher (“Yes” in step S420), the first threshold value setting section 45 changes the first threshold value (step S430).

Hereinafter, as in the aforementioned respective embodiments, the integral-value determination section 51 determines as to whether or not an integral value from a G sensor exceeds the first threshold value (integral value from G sensor≧first threshold value) (step S470). Then, a side airbag corresponding to the specified G sensor is inflated (step S510).

FIG. 19 is a characteristic chart in which a normal vehicle and a vehicle, which is high in vehicle height, are compared at a time of collision in terms of integral values. As shown in FIG. 19, integral values generated by collision with a normal vehicle (passenger car) reach the first threshold value after lapse of t1 seconds; in contrast, those generated by collision with a vehicle, which is high in vehicle height, reach the same after lapse of t2 seconds. This reveals that the amount of increase in the integral value generated by collision with the vehicle, which is high in vehicle height, is insufficient. Therefore, there is a possibility that collision determination may be delayed. Meanwhile, FIG. 20 shows a case where the first threshold value is changed when it is determined that a vehicle height of the other vehicle is high, as described in the seventh embodiment. Thereby, even if the other vehicle is a vehicle, which is high in vehicle height, time required for an integral value to reach the first threshold value can be shortened. As a result, time required to determine occurrence of a collision can be shortened.

Also, according to the seventh embodiment, the image capturing section such as a CCD camera is utilized for predicting a collision direction. Therefore, the collision direction can be predicted more surely.

### Eighth Embodiment

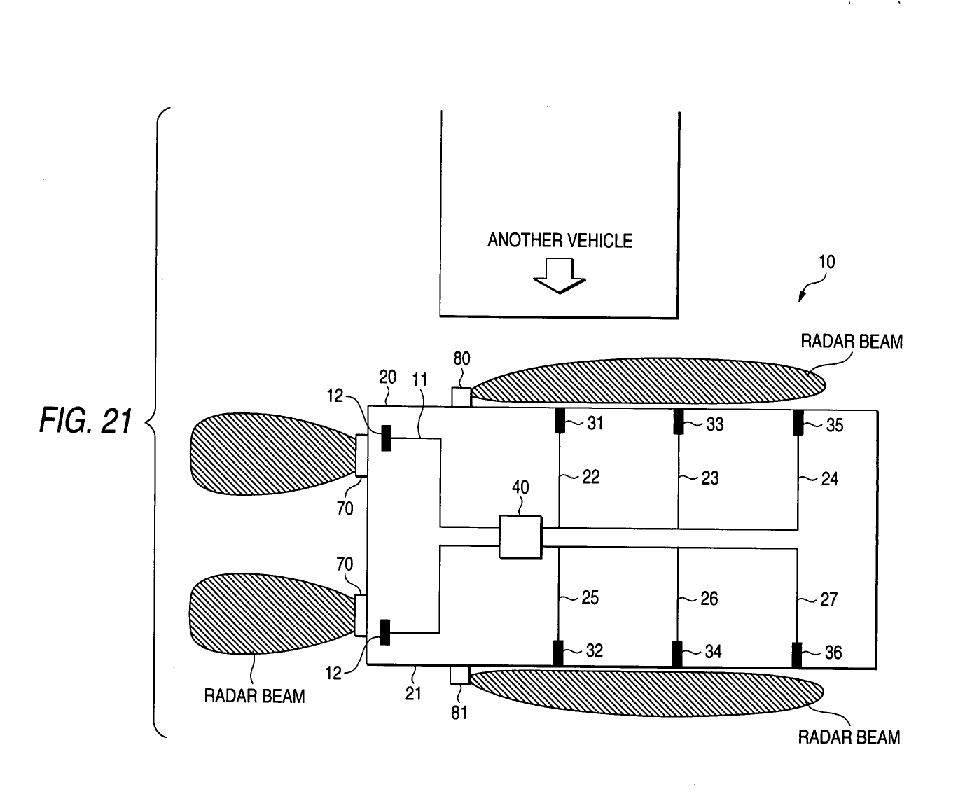

Next, an eighth embodiment of the invention will be described in detail with reference to FIG. 21. FIG. 21 is a schematic configuration view showing locations of the G sensors 31 to 36 and radars 70, 80, 81 of the vehicle 10 according to the eighth embodiment. As shown in FIG. 21, the pair of front radars 70 are disposed on the front of the vehicle 10. The radar 80 is disposed at a position close to a driver's seat on the right side surface 20 of the vehicle 10. The radar 81 is disposed at a position close to a front-passenger's seat on the left side surface 21 of the vehicle 10. Each of the radars 70, 80, 81 detects a position of another vehicle. The collision determination procedure control section 50 (FIG. 2) determines (predicts) collision side. The sampling-period control section 54 controls, on the basis of the predicted collision direction, the sampling period for either the G sensors 31, 33, 35 or the G sensors 32, 34, 36 disposed in the predicted collision direction.

More specifically, the pair of radars 70 respectively have the function of detecting another vehicle which is going to collide from ahead by means of radiating a radar beam forward of the vehicle 10. The radars 80, 81 have the function of detecting another vehicle (relative distance between the vehicle 10 and the other vehicle) before the other vehicle collides on the right side surface 20 or the left side surface 21 of the vehicle 10 by means of respectively radiating a radar beam along the right side surface 20 or the left side surface 21 of the vehicle 10. The other configurations are identical with those shown in FIGS. 2 to 4, and their repeated descriptions are omitted.

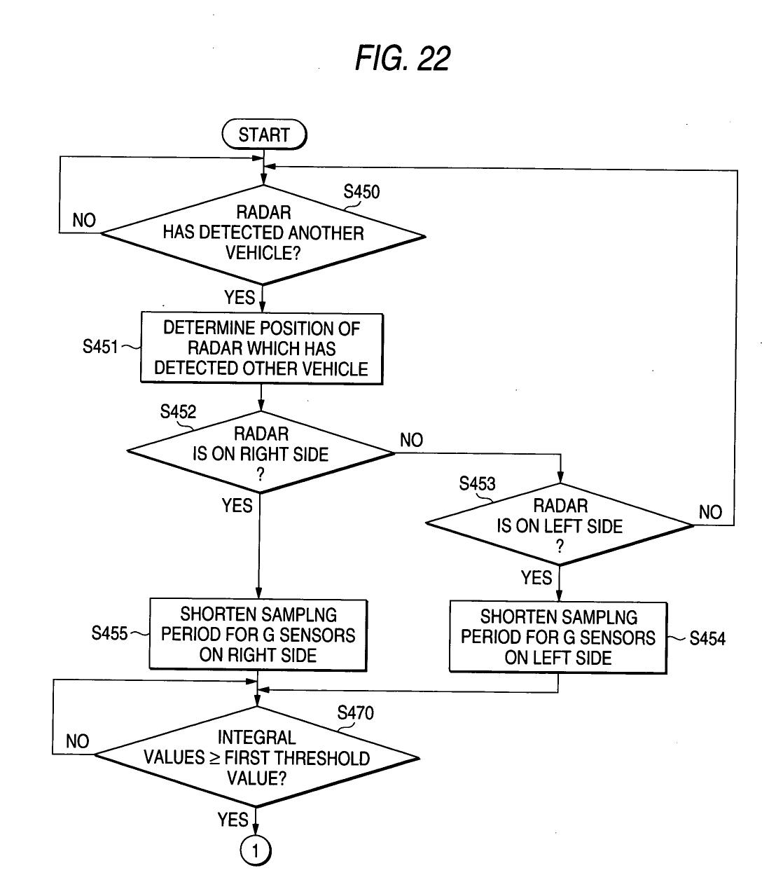

Hereinafter, the flowchart shown in FIG. 22 will be described. Specifically, the radars 80, 81 disposed on sides (the right side surface 20, the left side surface 21) of the vehicle 10 will be focused on. As shown in the flowchart in FIG. 22, the ECU 40 determines that as to whether or not the radars 80, 81 detect the other vehicle approaching the vehicle 10 (step S450). When in step S450 the ECU 40 determines that the other vehicle is detected (“Yes” in step S450), subsequently, the collision-direction prediction section 52 determines a position of the radar that has detected the other vehicle (step S451). More specifically, when the radar 80 disposed on the right side surface 20 detects the other vehicle (“Yes” in step S452), the sampling-period control section 54 shortens sampling period for the G sensors 31, 33, 35 on the right side surface 20 of the vehicle 10 (step S455).

On the other hand, when the radar 81 disposed on the left side surface 21 detects the other vehicle (“Yes” in step S453), the sampling-period control section 54 shortens sampling period for the G sensors 32, 34, 36 on the left side surface 21 of the vehicle 10 (step S454). Hereinafter, after integral values are compared with the first threshold value in step S470, the same procedure as described above (steps S500 to S510 in FIG. 5) is performed, whereby a corresponding side airbag is inflated.

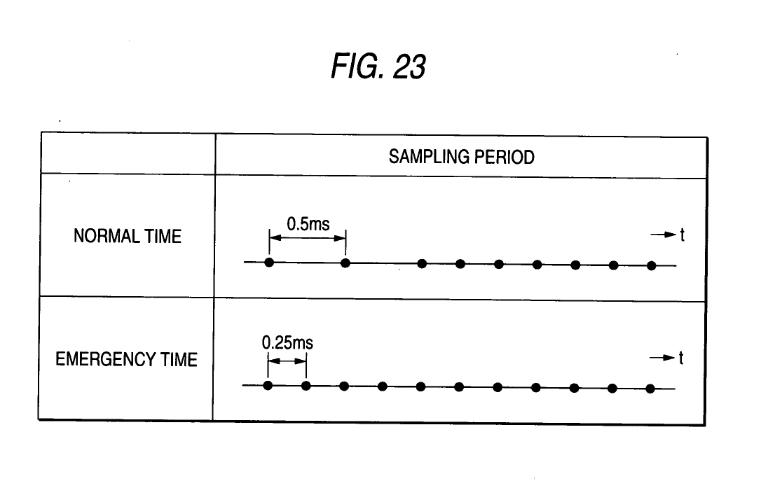

FIG. 23 shows a time chart according to the eighth embodiment. The time chart shows that sampling period for the G sensors 31, 33, 35 on the right side surface 20 of the vehicle 10 is changed from “0.5 ms” to “0.25 ms”, and that sampling (integration) is performed at the interval of 0.25 ms.

In the eighth embodiment, the ECU 40 integrates acceleration values output from the G sensors 31 to 36 disposed on the right side surface 20 or the left side surface 21 and which are detected by the radar 80, 81. However, the collision-position prediction section 53 may specify a G sensor, which is the closest to the radars 80, 81, rather than the plurality of G sensors 31 to 36, and the sampling-period control section 54 may shorten the sampling period for only the thus-specified G sensor. More specifically, in FIG. 21, a G sensor detected by the radar 80 (a G sensor which is closest to the radar 80) is the G sensor 31. Accordingly, the sampling-period control section 54 shortens the sampling period for only the G sensor 31.

Alternatively, as is in the fourth embodiment, the sampling-sequence control section 56 may give priority to a G sensor detected by the radars 80, 81 in integrating acceleration values. For example, it is assumed that the G sensor 32 is detected by the radar 80. The auxiliary collision-position prediction section 57 specifies the G sensor 31 located at the position opposite to the G sensor 32 as the safing G sensor. Then, sampling (integration) is performed in the sampling sequence shown in FIG. 11.

Alternatively, as is in the aforementioned fifth embodiment, when the radar 80 predicts a collision on the G sensor 31, the collision-position prediction section 53 specifies the G sensor 33 adjacent to the G sensor 31 in addition to the main G sensor 31; and the auxiliary collision-position prediction section 57 specifies the safing G sensor located at the side opposite to the G sensor 31. Then, the sampling-sequence control section 56 gives priority to the main G sensor 31, the adjacent G sensor 33, and the safing G sensor 32 in integrating acceleration values. In this case, as described above, actual inflation of a side airbag is performed on the basis of integral values from the G sensor 31, 33, 32 (integral values from G sensors 31, 32, 33≧the first threshold value).

Also, according to the eighth embodiment, the radars 80, 81 are utilized for predicting a collision direction. Therefore, the collision direction can be predicted more surely. Furthermore, in addition to detecting collision direction of a collision with another vehicle prior to the collision, the airbag apparatus according to the eighth embodiment can prevent delayed inflation of an airbag caused by delay due to communication processing and arithmetic processing. As a result, protection of occupants can be surely accomplished.

### Ninth Embodiment

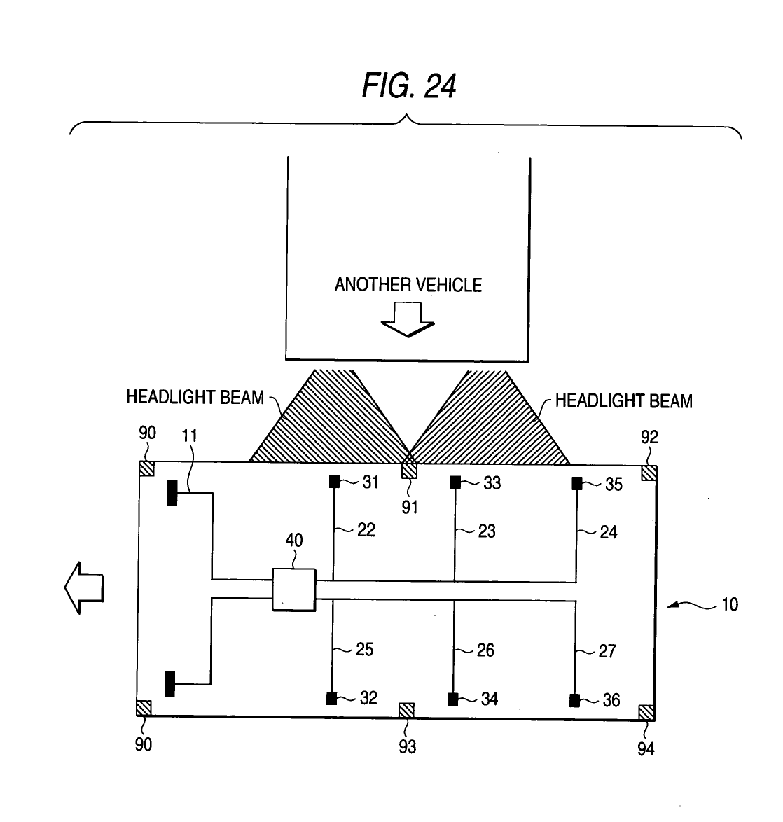

Next, a ninth embodiment of the invention will be described in detail with reference to FIG. 24. FIG. 24 is a schematic configuration view showing arrangement of the G sensors 31 to 36 and optical sensors 90 to 94 of the vehicle 10 with an airbag apparatus according to the ninth embodiment. As shown in FIG. 24, the optical sensors 90 to 94 for detecting (receiving light of) headlight of another vehicle are disposed at predetermined positions (three positions) on the right side surface 20 and the left side surface 21 of the vehicle 10. The collision determination procedure control section 50 (FIG. 2) determines (predicts) a collision direction of collision with the other vehicle on the basis of light from the headlight of the other vehicle detected by the optical sensors 90 to 94. The sampling-period control section 54 controls sampling period for either the G sensors 31, 33, 35 or the G sensors 32, 34, 36 located in the collision direction on the basis of the thus-predicted collision direction.

Therefore, the optical sensors 90 to 94 are respectively mounted on the right side surface 20 and on the left side surface 21 of the vehicle 10 with their light-receiving surfaces facing outward, and have the function of detecting a headlight from another vehicle prior to a collision with the other vehicle on the right side surface 20 or the left side surface 21 of the vehicle 10.

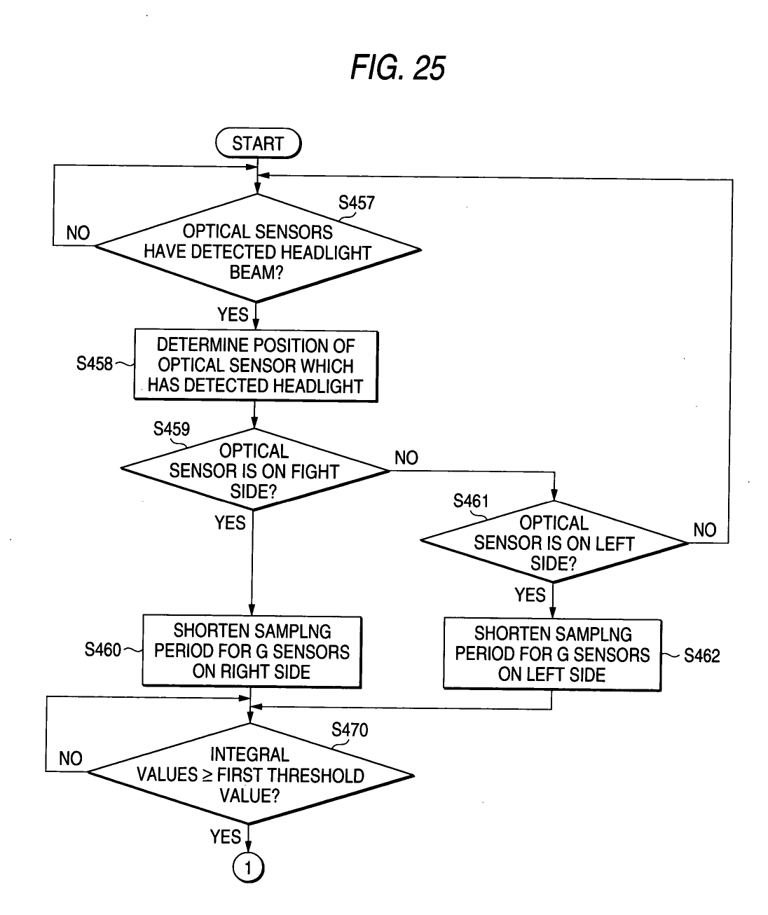

Hereinafter, the flowchart shown in FIG. 25 will be described. As shown in the flowchart in FIG. 25, the ECU 40 first determines as to whether or not any of the optical sensors 90 to 94 detects (received light of) a headlight from another vehicle (step S457). When the ECU 40 determines that at least one of the optical sensor 90 to 94 have detected the headlight (“Yes” in step S457), subsequently, the collision-direction prediction section 52 determines a position of the optical sensor, which has detected the headlight (step S458). More specifically, the collision-direction prediction section 52 determines whether or not the optical sensor is located on the right side surface 20 (step S459). When the collision-direction prediction section 52 determines that the optical sensor is located on the right side surface 20 (“Yes” in step S459), the sampling-period control section 54 shortens the sampling period for the G sensors 31, 33, 35 disposed on the right side surface 20 of the vehicle 10 (step S460).

On the other hand, when the collision-direction prediction section 52 determines that the optical sensor having detected headlight is not located on the right side surface 20 (“No” in step S459), the processing proceeds to step S461. Then, the collision-direction prediction section 52 determines as to whether or not the optical sensor having detected the headlight is located on the light side 21 (step S461). When in step S461 the collision-direction prediction section 52 determines that the optical sensor having detected the headlight is located on the left side surface 21 (“Yes” in step S461), the sampling-period control section 54 shortens sampling period for the G sensors 32, 34, 36 disposed on the left side surface 21 (step S462). Hereinafter, the same procedure as described above (steps S500 to S510 in FIG. 5) is performed, whereby a corresponding side airbag is inflated.

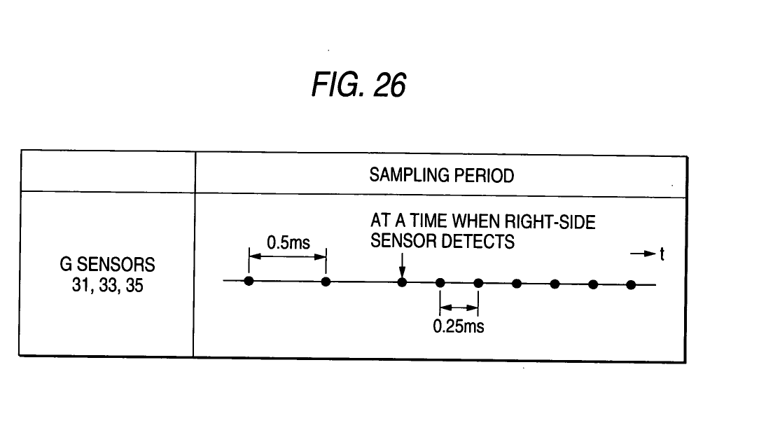

FIG. 26 shows a time chart according to the ninth embodiment. The time chart shows one case where one of the optical sensors 90, 91, 92 has received headlight. In this case, the sampling-period control section 54 changes the sampling period for the G sensors 31, 33, 35 on the right side surface 20 from 0.5 msec to 0.25 msec.

In the ninth embodiment, the ECU 40 integrates acceleration values output from the plurality of G sensors 31 to 36, which are disposed on either the right side surface 20 or on the left side surface 21 where the optical sensor (90, 91, 92) having detected headlight is disposed. However, the collision-position prediction section 53 may specify a G sensor, which is the closest to the optical sensor having detected the headlight, rather than plural G sensors. The sampling-period control section 54 may shorten sampling period for only thus-specified G sensor. Then, the ECU 40 may integrate acceleration values output only from the thus-specified G sensor for the (shortened) emergency sampling period. More specifically, in FIG. 24, the G sensor 33 is the closest to the optical sensor 91 having detected the headlight. Accordingly, the sampling-period control section 54 shortens the sampling period for only the G sensor 33.

Also, according to the ninth embodiment, the optical sensors 90 to 92 are utilized for predicting a collision direction. Therefore, the collision direction can be predicted more surely. Furthermore, in addition to detecting collision direction of a collision with another vehicle prior to the collision, the airbag apparatus according to the ninth embodiment can prevent delayed inflation of an airbag caused by delay due to communication processing and arithmetic processing. As a result, protection of occupants can be surely accomplished.

As described above, the airbag apparatus according to embodiments of the invention is suitable for use in an airbag system which, in a case where lateral collision with another vehicle is detected, inflates a side airbag to protect occupants.

1. An airbag apparatus comprising:
a controller that conducts sampling of acceleration values output from a plurality of acceleration sensors disposed on a vehicle and controls inflation of an airbag based on the sampled acceleration values;
a prediction unit that predicts a collision direction in which collision with another vehicle would occur; and
a sampling-period control unit that, when the prediction unit predicts the collision direction, shortens a sampling period for the acceleration sensor disposed in the predicted collision direction in comparison with sampling period for the other acceleration sensors, wherein:
after the sampling-period control unit shortens the sampling period, the controller determines whether or not to inflate the airbag, based on the sampled acceleration values output from the acceleration sensor disposed in the predicted collision direction.

2. The airbag apparatus according to claim 1, wherein the sampling conducted by the controller integrates the acceleration values output from the acceleration sensors for the sampling period, subsequently.

3. The airbag apparatus according to claim 1, further comprising:
a monitoring unit that monitors surroundings of the vehicle, wherein:
the prediction unit predicts the collision direction based on information output from the monitoring unit.

4. The airbag apparatus according to claim 2, further comprising:
an integral-value determination unit that determines whether or not the integral value from each of the acceleration sensors exceeds a second threshold value, wherein:
when the integral-value determination unit determines that the integral value from one of the acceleration sensors exceeds the second threshold value, the prediction unit predicts the collision direction based on a direction in which the one of the acceleration sensors is disposed.

5. The airbag apparatus according to claim 4, further comprising:
a threshold-value setting unit that sets a first threshold value and the second threshold value being smaller than the first threshold value, wherein:
after the sampling-period control unit shortens the sampling period, the integral-value determination unit determines whether or not the integral value from at least one of the acceleration sensors disposed in the predicted collision direction exceeds the first threshold value; and
when the integral-value determination unit determines that the integral value from the at least one of the acceleration sensors disposed in the predicted collision direction exceeds the first threshold value, the controller inflates the airbag disposed in the predicted collision direction.

6. The airbag apparatus according to claim 4, wherein:
the prediction unit has a collision-position prediction section that specifies the acceleration sensor disposed at a collision position where the collision with the other vehicle would occur based on the integral value from each of the acceleration sensors; and
the sampling-period control unit shortens the sampling period for the acceleration sensor specified by the collision-position prediction section.

7. The airbag apparatus according to claim 1, wherein:
the acceleration sensors include a Y-axis acceleration sensor for detecting lateral collision with the other vehicle; and
the prediction unit predicts the collision direction based on acceleration values output from the Y-axis acceleration sensor.

8. An airbag apparatus comprising:
a controller that conducts sampling of acceleration values output from a plurality of acceleration sensors disposed on a vehicle and controls inflation of an airbag based on the sampled acceleration values;
a prediction unit that predicts a collision direction in which collision with another vehicle would occur; and
a sampling-period control unit that, when the prediction unit predicts the collision direction, gives priority in the sampling of the acceleration values to the acceleration sensor disposed in the predicted collision direction, wherein:
after the sampling-period control unit gives the priority, the controller conducts the sampling of the acceleration values in accordance with the priority and determines whether or not to inflate the airbag, based on the sampled acceleration values output from the acceleration sensor to which the priority is given.

9. The airbag apparatus according to claim 8, wherein the sampling conducted by the controller integrates the acceleration values output from the acceleration sensors for the sampling period, subsequently.

10. The airbag apparatus according to claim 8, further comprising:
a monitoring unit that monitors surroundings of the vehicle, wherein:
the prediction unit predicts the collision direction based on information output from the monitoring unit.

11. The airbag apparatus according to claim 9, further comprising:
an integral-value determination unit that determines whether or not the integral value from each of the acceleration sensors exceeds a second threshold value, wherein:
when the integral-value determination unit determines that the integral value from one of the acceleration sensors exceeds the second threshold value, the prediction unit predicts the collision direction based on a direction in which the one of the acceleration sensors is disposed.

12. The airbag apparatus according to claim 11, further comprising:
a threshold-value setting unit that sets a first threshold value and the second threshold value being smaller than the first threshold value, wherein:
after the sampling-period control unit give the priority, the integral-value determination unit determines whether or not the integral value from at least one of the acceleration sensors disposed in the predicted collision direction exceeds the first threshold value; and
when the integral-value determination unit determines that the integral value from the at least one of the acceleration sensors disposed in the predicted collision direction exceeds the first threshold value, the controller inflates the airbag disposed in the predicted collision direction.

13. The airbag apparatus according to claim 8, further comprising:
an auxiliary collision-position prediction unit, wherein:
the prediction unit has a collision-position prediction section that specifies one of the acceleration sensors disposed at a collision position where the collision with the other vehicle would occur based on the integral value from each of the acceleration sensors;
the auxiliary collision-position prediction unit specifies another one of the acceleration sensors disposed at a position opposite to the acceleration sensor specified by the collision-position prediction section; and
the sampling-period control unit gives the priority to the acceleration sensor specified by the collision-position prediction section and the acceleration sensor specified by the auxiliary collision-position prediction unit.

14. The airbag apparatus according to claim 8, further comprising:
an auxiliary collision-position prediction unit, wherein:
the prediction unit has a collision-position prediction section that specifies one of the acceleration sensors disposed at a collision position where the collision with the other vehicle would occur based on the integral value from each of the acceleration sensors;
the collision-position prediction section further specifies an acceleration sensor adjacent to the specified acceleration sensor;
the auxiliary collision-position prediction unit specifies another one of the acceleration sensors disposed at a position opposite to the one of the acceleration sensors specified by the collision-position prediction section; and
the sampling-period control unit gives the priority to the one of the acceleration sensors specified by the collision-position prediction section; the adjacent acceleration sensor; and the acceleration sensor specified by the auxiliary collision-position determination unit.

15. The airbag apparatus according to claim 2, further comprising:
a threshold-value setting unit that sets a first threshold value and the second threshold value being smaller than the first threshold value,
a storage table that stores the integral values from the acceleration sensors, wherein:
the threshold-value setting unit changes at least one of the first and second threshold values for the acceleration sensor the integral value from which is the highest among the stored integral values.

16. The airbag apparatus according to claim 15, wherein the threshold-value setting unit changes the first threshold value for the for the acceleration sensor the integral value from which is the highest, to a third threshold value being smaller than the first threshold value.

17. The airbag apparatus according to claim 15, further comprising:
a failure detection unit that detects failure of the acceleration sensors, wherein:
the prediction unit predicts the collision direction based on the integral values stored in the storage table; and
when the failure detection unit detects failure of at least one of the acceleration sensors, the prediction unit is prohibited from predicting the collision direction based on the integral values stored in the storage table.

18. The airbag apparatus according to claim 9, further comprising:
a threshold-value setting unit that sets a first threshold value and the second threshold value being smaller than the first threshold value,
a storage table that stores the integral values from the acceleration sensors, wherein:
the threshold-value setting unit changes at least one of the first and second threshold values for the acceleration sensor the integral value from which is the highest among the stored integral values.

19. The airbag apparatus according to claim 18, wherein the threshold-value setting unit changes the first threshold value for the for the acceleration sensor the integral value from which is the highest, to a third threshold value being smaller than the first threshold value.

20. The airbag apparatus according to claim 18, further comprising:
a failure detection unit that detects failure of the acceleration sensors, wherein:
the prediction unit predicts the collision direction based on the integral values stored in the storage table; and
when the failure detection unit detects failure of at least one of the acceleration sensors; the prediction unit is prohibited from predicting the collision direction based on the integral values stored in the storage table.

21. The airbag apparatus according to claim 5, further comprising:
an information acquisition unit that acquires vehicle height of the other vehicle, wherein:
the threshold-value setting unit changes the first threshold value based on the acquired vehicle height of the other vehicle.

22. The airbag apparatus according to claim 12, further comprising:
an information acquisition unit that acquires vehicle height of another vehicle, wherein:
the threshold-value setting unit changes the first threshold value based on the acquired vehicle height of the other vehicle.

23. The airbag apparatus according to claim 1, further comprising:
a radar sensor that detects an object around the vehicle, wherein:
the prediction unit predicts the collision direction based on the detected object around the vehicle.

24. The airbag apparatus according to claim 8, further comprising:
a radar sensor that detects an object around the vehicle, wherein:
the prediction unit predicts the collision direction based on the detected object around the vehicle.

25. The airbag apparatus according to claim 1, further comprising:
a light-source detection unit that detects a headlight beam irradiated from the other vehicle to the vehicle, wherein:
the prediction unit predicts the collision direction based on the detected headlight beam.

26. The airbag apparatus according to claim 8, further comprising:
a light-source detection unit that detects a headlight beam irradiated from the other vehicle to the vehicle, wherein:
the prediction unit predicts the collision direction based on the detected headlight beam.
